(19) United States
(12) Patent Application Publication
(10) Pub. No.: US 2012/0226978 A1
(43) Pub. Date: Sep. 6, 2012

(54) Graphical User Interface Having An Orbital Menu System

(75) Inventors: Maike HARBERTS, Koln (DE); Nils PORRMANN, London (GB); Steffen SKOPP, Dusseldorf (DE)

(73) Assignee: Leica Camera AG, Solms (DE)

(21) Appl. No.: 13/040,796

(22) Filed: Mar. 4, 2011

(51) Int. Cl. G06F 3/048

(52) U.S. Cl. 715/702

(57) ABSTRACT

A graphical user interface for display on a touchscreen display of an electronic user device includes an orbital menu that has a plurality of displayed selectable icons arranged in a first essentially circular pattern, wherein the selectable icons are a predetermined number of otherwise available icons for a current menu level of the orbital menu. In certain embodiments, the available icons are user selectable so as to be able to access device functions, menu levels, device options, etc. The orbital menu may include a number of hidden icons, which correspond to the remaining available icons that otherwise exceed the predetermined number. Additionally, the orbital menu may include a graphical representation of the selectable icons as spinning along the first essentially circular pattern in response to a user contact of the orbital menu provided using the touchscreen display.

### FIELD OF THE INVENTION

The present invention relates generally to a graphical user interface for use in connection with electronic user devices, and more particularly to a graphical user interface comprising an orbital menu system for navigating available functions, features and options of an electronic user device.

### BACKGROUND OF THE INVENTION

Electronic user devices, such as personal digital assistants (PDAs), cellular telephones, digital cameras, smartphones, etc., are continually evolving and being used to access an ever-increasing array of services and content. With this additional functionality, however, comes a need for an increasingly complex graphical user interface and menu system. The graphical user interface and menu system for such electronic user devices is essentially the gateway through which users are able to access available content, features and functions.

Traditional electronic user device menu systems involve a complex tree-like structure of menus and sub-menus corresponding to the various available features and content. As a result, locating the proper sub-menu for a desired feature can be a laborious and frustrating trial-and-error endeavor for the user. As a consequence, the traditional antiquated menu systems for modern electronic user devices are essentially becoming bottlenecks to adding additional functionality to such devices.

Accordingly, there is a need for an improved graphical user interface and menu system for navigating the myriad of functions, features and options available on modern electronic user devices.

### SUMMARY OF THE INVENTION

Disclosed and claimed herein are methods and electronic user devices for implementing an orbital menu system in a graphical user interface. In one embodiment, a method includes determining a plurality of available icons for a current menu level of the orbital menu system, wherein the available icons correspond to at least one of accessing device functions, menu levels and device options. The method further includes displaying an orbital menu in which only a predetermined number of the available icons are displayed as a plurality of selectable icons in a first essentially circular pattern, and wherein the remaining available icons for the current menu level are hidden from user view. Additionally, the method includes graphically representing the selectable icons as spinning along the first essentially circular pattern in response to a user contact of the orbital menu provided using the touchscreen display.

Additionally, disclosed and claimed herein is a graphical user interface of an electronic user device with a touchscreen display. The graphical user interface includes an orbital menu that has a plurality of displayed selectable icons arranged in a first essentially circular pattern, wherein the selectable icons are a predetermined number of a plurality of available icons for a current menu level of the orbital menu, wherein the available icons correspond to at least one of accessing device functions, menu levels and device options. The orbital menu also includes a plurality of hidden icons, wherein the hidden icons correspond to the remaining available icons that exceed the predetermined number. Additionally, the orbital menu includes a graphical representation of the selectable icons as spinning along the first essentially circular pattern in response to a user contact of the orbital menu provided using the touchscreen display.

Other aspects, features, and techniques of the invention will be apparent to one skilled in the relevant art in view of the following description of the exemplary embodiments of the invention.

### BRIEF DESCRIPTION OF THE DRAWINGS

FIG. 1 illustrates a simplified schematic of an electronic user device configured to implement one or more embodiments of the invention;

FIGS. 2A-2F depict an electronic user device, such as the electronic user device of FIG. 1, configured with a graphical user interface implementing various aspects of the invention; and

FIGS. 3A-3F are screenshots taken from an electronic user device, such as the electronic user device of FIG. 1, depicting various aspects of an orbital menu system configured in accordance with the principles of the invention;

FIGS. 4A-4D are screenshots taken from an electronic user device, such as the electronic user device of FIG. 1, depicting additional functionalities and features of an orbital menu system configured in accordance with the principles of the invention;

FIGS. 5A-5E are various additional screenshots taken from an electronic user device, such as the electronic user device of FIG. 1, depicting the customization functionality of an orbital menu system configured in accordance with the principles of the invention;

FIGS. 6A-6C are various additional screenshots taken from an electronic user device, such as the electronic user device of FIG. 1, depicting additional functionalities and features of an orbital menu system configured in accordance with the principles of the invention; and

FIGS. 7A-7C depict a process for implementing one or more aspects of the invention.

### DETAILED DESCRIPTION OF THE EXEMPLARY EMBODIMENTS

The present disclosure relates generally to a graphical user interface for implementing an orbital menu to be displayed on a touchscreen display of electronic user devices.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the following detailed description, numerous specific details are set forth in order to provide a thorough understanding of the present invention. However, it should be appreciated that the invention may be practiced without such specific details. Additionally, for brevity sake well-known methods, procedures, components, and circuits have not been described in detail.

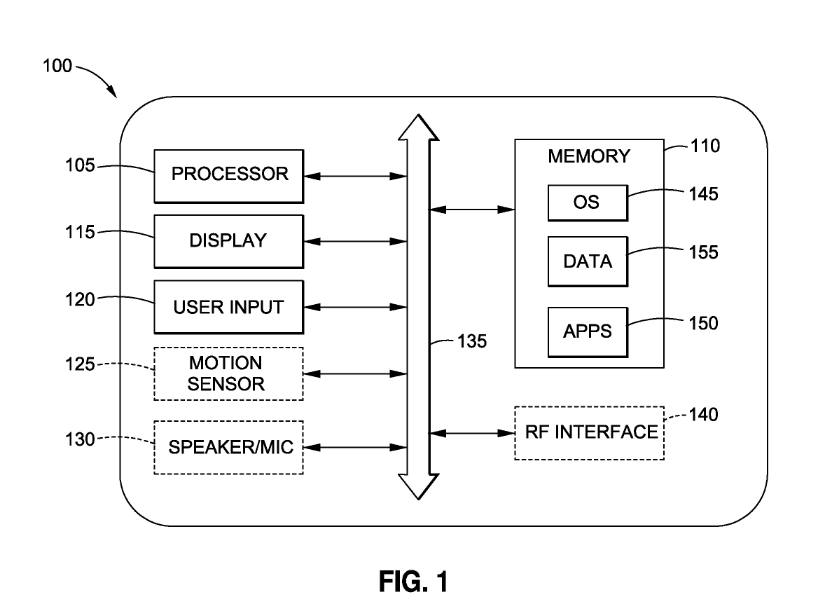

With reference now to FIG. 1, depicted is one embodiment of an electronic user device 100 capable of implementing one or more aspects of the invention. The electronic user device 100 may be a cellular telephone, smartphone, PDA, digital camera, handheld computer, etc.

As shown in FIG. 1, the exemplary electronic user device 100 includes a processor 105, a memory 110, a touchscreen display 115 and a user input 120, each being interconnected by bus 135. The electronic user device 100 may also include additional optional components, such as an optional motion sensor 125, optional speaker/microphone 130 and/or an optional radio frequency interface 140 that performs the function of transmitting and receiving radio frequency signals from one or more wireless networks. It should be appreciated that the processor 105 may be a general processor, a digital signal processor, an application-specific integrated circuit, digital logic device, an analog processor or other now known processing circuit.

With respect to the user input 120, it may be implemented using a keypad, such as a push-button dialing pad, a keyboard or the like. The touchscreen display 115 may be an LCD or any other type of display commonly used in consumer electronic devices. Since the display 115 is preferably touch-sensitive, it may serve the dual function of being a display screen as well as part of the user input 120. The optional motion sensor 125 may be comprised of any known motion sensing technology, such as a three-dimensional acceleration and/or velocity sensor technology, two-dimensional acceleration and/or velocity sensor technology, a strain or tilt detector, or any other sensor capable of detecting movement of the handheld device 100 by its user.

Memory 110 may include random access memory and/or non-volatile memory, such as one or more magnetic disk storage devices, one or more optical storage devices and/or flash memory. As shown, stored in memory 110 is at least one operating system 145, which comprises procedures (or sets of instructions) for handling basic system services and for performing hardware dependent tasks. One or more applications 150 and data 155 may also be stored in memory.

It should further be appreciated that the memory 110 may include computer instructions, as part of the operating system 145 and/or an application 150, that determine one or more points of contact, direction of movement and/or speed of movement along the device's touchscreen display 115.

Although not necessarily pertinent to the scope of the disclosure, it should be appreciated that the applications 150 may comprise one or more of a web browser, chat interface application, a camera application, a phone dialer program, email client, word processing application, etc.

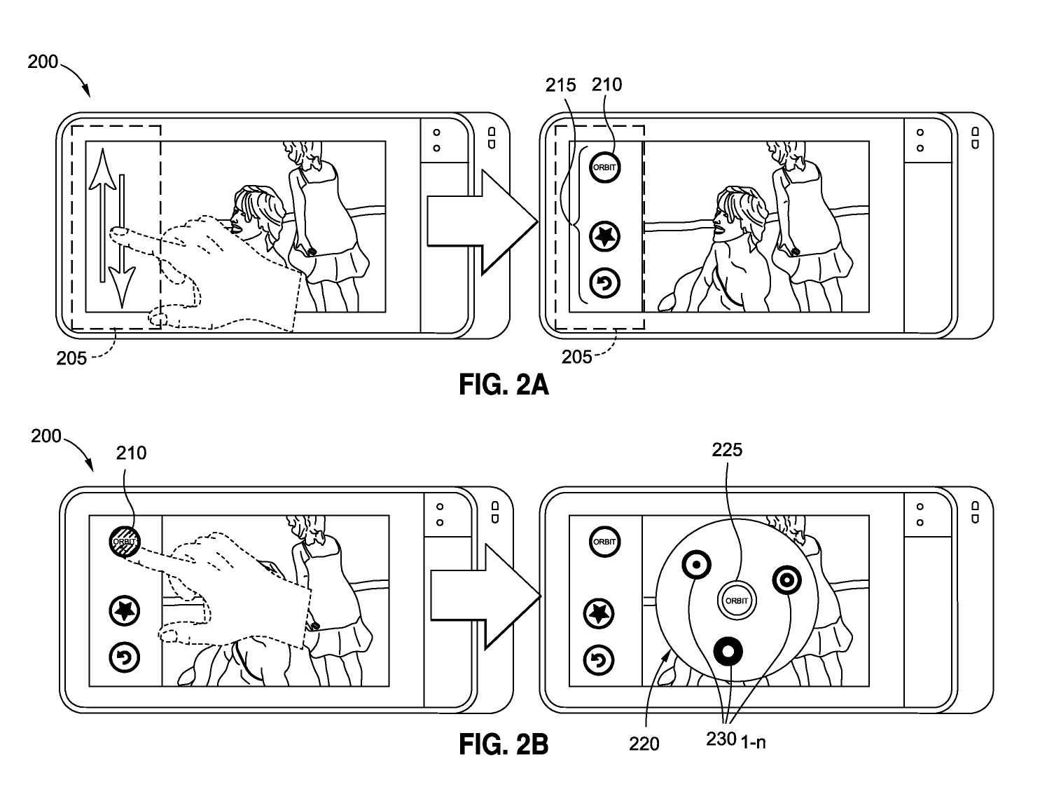

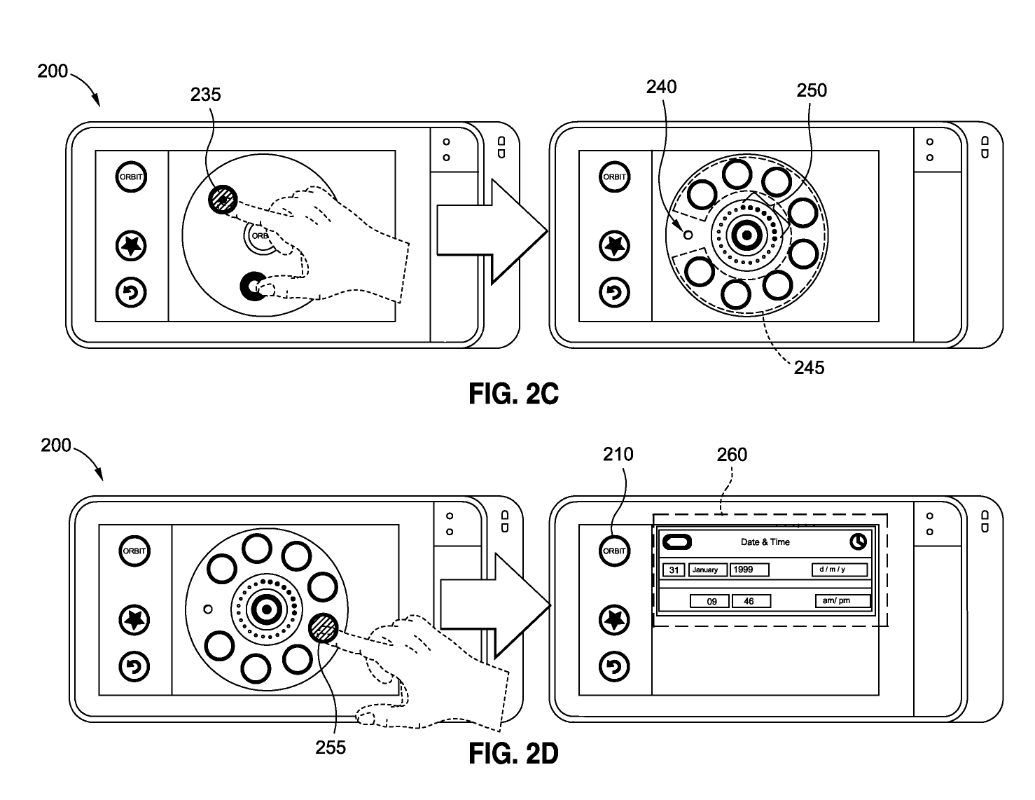

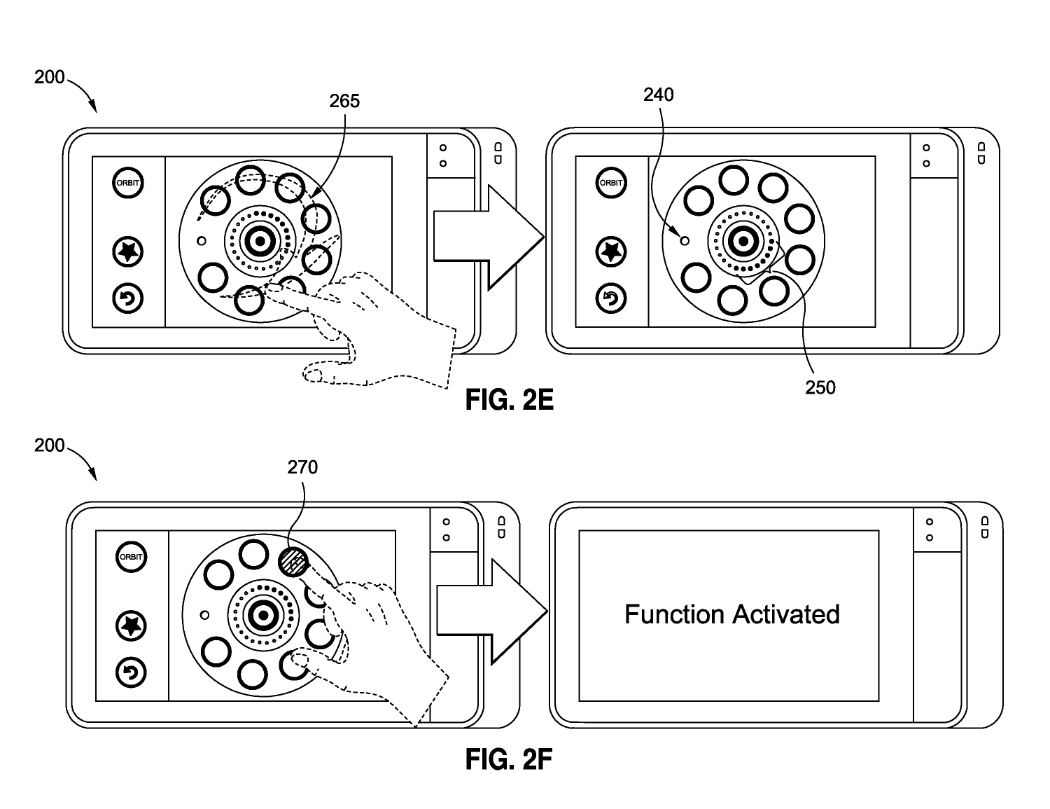

Referring now to FIGS. 2A-2F, depicted is the electronic user device 200 of FIG. 1 configured with a graphical user interface implementing various aspects of the invention. By way of a non-limiting example, FIG. 2A depicts the display of the electronic user device 200 as having at least a first touch-sensitive section 205. In the embodiment of FIG. 2A, the graphical user interface of the device 205 is configured to detect user contact of the first touch-sensitive section 205, coupled with a predetermined movement. In response, side menu 215 may be displayed within the first touch-sensitive section 205 of the graphical user interface. In the embodiment of FIG. 2A, side menu 215 includes a plurality of selection icons corresponding to various options, as will be described in more detail below. As also shown, one such selection icon is the orbit launcher icon 210, which has been associated with the orbital menu system of the present invention.

Referring now to FIG. 2B, a user is shown as selecting the orbit launcher icon 210 by, for example, touching/contacting the orbit launcher icon 210 on the display screen of the electronic user device 200. The result is that the orbital menu system 220 is launched or otherwise displayed on the screen of the electronic user device 200, as shown. In the depicted example, the orbital top menu 220 comprises a plurality of selectable top menu icons 230₁₋ₙ arranged in an essentially oval, circular or orbital pattern around a current menu icon 225. In various embodiments, and as will be described in more detail below, the selectable top menu icons 230₁₋ₙ may be used to access available submenus, function, options or the like, while the current menu icon 225 may be used to simply indicate the currently selected menu, submenu or function. In the embodiment of FIG. 2B, the current menu icon 225 corresponds to what ever the currently selected menu or sub-menu may be, which in this case is of course the orbital top menu 220.

Referring now to FIG. 2C, a user is shown as selecting one of the selectable top menu icons 230₁₋ₙ by touching/contacting icon 235, the result of which is that the graphical user interface for the electronic user device 200 displays an orbital submenu having a plurality of selectable submenu icons 245. As shown, the plurality of selectable submenu icons 245 are arranged in an essentially oval, circular or orbital pattern around the current menu icon (not labeled). It should be appreciated that each of the plurality of selectable submenu icons 245 may correspond to at least a subset of the otherwise available lower level submenus, specifics functions, features or options.

Moreover, and as will be described in more detail below, one aspect of the selectable submenu icons 245 is that the user may not only select individual icons, but may also rotate the positions of the selectable submenu icons 245 around the orbital submenu. This may be done by, for example, touching/contacting a portion of the orbital submenu and, while still in contact therewith, applying a swirling or sweeping motion in either a clockwise or counterclockwise direction. This feature may be referred to as a ‘spin effect’ or ‘spinning’ the orbital menu.

As also shown in FIG. 2C, the orbital submenu further includes a vanishing point 240 which allows the graphical user interface to display, at any one time, only a subset of the icons that are otherwise included or available on the currently selected menu. The vanishing point 240 may be used to hide/show additional icons which are part of the current orbital submenu such that only some predetermined number of icons (e.g., 4, 6, 8, etc.) are displayed on the orbital submenu at any one time. Thus, as a user ‘spins’ the orbital menu the set of displayed selectable icons will change, depending of course on how many total available icons there may be on the currently selected submenu. For example, if there are only a total of 6 total available icons on a given submenu, and the orbital menu system is configured to display up 8 icons at a time, as is the case in FIG. 2C, then spinning the orbital menu would not hide or show any additional icons since all of the available icons are already being displayed.

If, on the other hand, there are a total of 24 available icons on a given submenu, such as is the case in FIG. 2C, the orbital menu system may be configured to display only 8 icons at a time (see e.g., FIG. 2C). This is beneficial since it would be confusing to a user to have all 24 available icons displayed at the same time. That is, any text or graphic used to indicate the function of a particular icon would have to be very small to fit within the graphical user interface. Thus, one aspect of the disclosed novel graphical user interface is to enable the use of larger icons to be displayed by hiding some of the other icons that may otherwise be available in a given submenu. To that end, as a user spins the orbital menu as described above, the graphical effect would be for the displayed icons to graphically appear to vanish or sink into one side of the vanishing point 240, while previously un-displayed icons would graphically appear to emerge from the opposite side of the vanishing point 240. This visual effect, which is described in much more detail below, functions to enable larger, easier to read icons to be displayed around the orbital menu system, but at the same time allowing the user to access a much larger number of icons without even having to change menu levels.

As a means for the user to quickly identifying how many un-displayed icons there are available on a given menu level, as well as referencing where, amongst those available icons, the currently displayed icons reside, another aspect of the orbital menu system is an icon tracker 250. In certain embodiments, the icon tracker 250 is comprised of a series of visible icon indicators, such as dots or other symbols, arranged in an essentially circular pattern along an inner ring of the selectable submenu icons 245. The number of visible icon indicators which comprise the icon tracker should preferably correspond to the total number of selectable icons on the current menu level. Additionally, the currently displayed selectable submenu icons 245 should preferably be represented within the icon tracker 250 in a manner which differentiates or distinguishes them from the un-displayed icons. To that end, in the embodiment of FIG. 2C this is done by highlighting/enlarging the particular 8 visible icon indicators within the icon tracker 250 that correspond to the 8 currently-displayed submenu icons 245. In the embodiment of FIG. 2C, the visible icon indicators that correspond to the currently-displayed selectable submenu icons 245 are shown as filled dots, while the other available, but otherwise un-displayed icons on the current menu level are shown as unfilled dots. It should of course be appreciated that any other symbol or indicator may be similarly used.

As the user “spins” the orbital submenu, using a clockwise or counterclockwise swirling motion as described above, the 8 dots/symbols of the icon tracker 250 that are highlighted/enlarged correspondingly rotate around so as to correspond to the location/position of the 8 submenu icons 245 that are then caused to be displayed by the user by virtue of spinning the orbital menu and the above-mentioned effect of the vanishing point 240 in hiding/showing the selectable submenu icons 245.

FIG. 2D illustrates a user selecting one of the selectable submenu icons 245 by touching/contacting icon 255, the result of which is that the electronic user device 200 invokes the function corresponding to icon 255. In this case, that function is the display of a date & time window 260. It should of course be appreciated that the date & time window 260 is described by way of illustration only, and that numerous other functions, options or features (including other submenus) may be similarly invoked by the user by touching/contacting any of the selectable submenu icons 245.

FIG. 2E more clearly shows how the applied spin effect 265 correspondingly causes the icon tracker 250 to rotate such that the visible icon indicators that are highlighted/enlarged (i.e., the filled dots) graphically represent where the currently-displayed submenu icons are with respect to the total available icons on the current level.

Following the above-described spin effect 265 causes additional submenu icons to be displayed that were, prior to such spinning, not displayed, FIG. 2F shows how the user may then select the now-displayed icon 270 to invoke some desired function, additional submenu, option or the like.

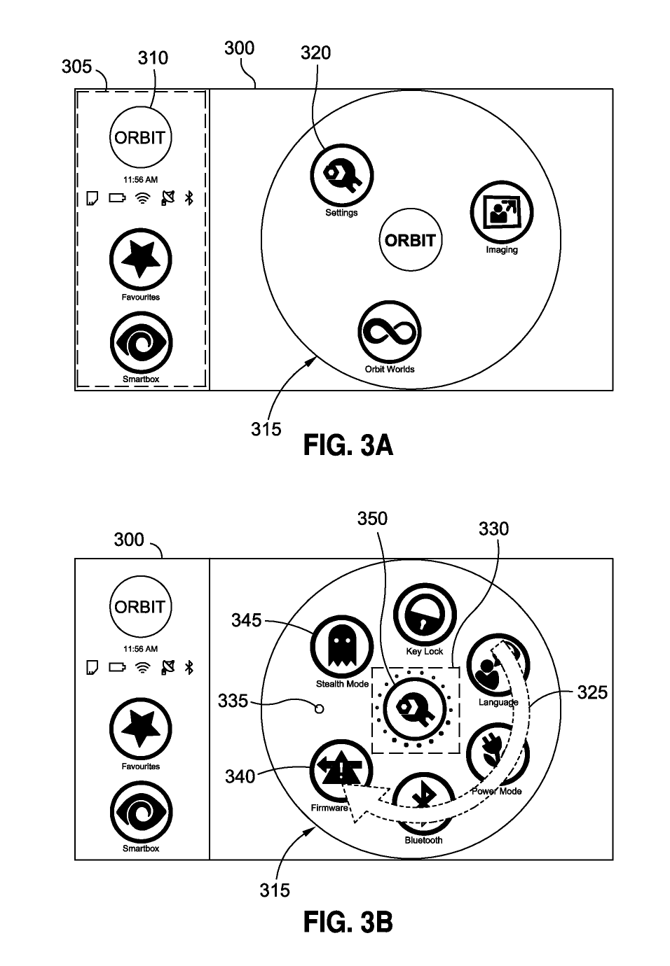

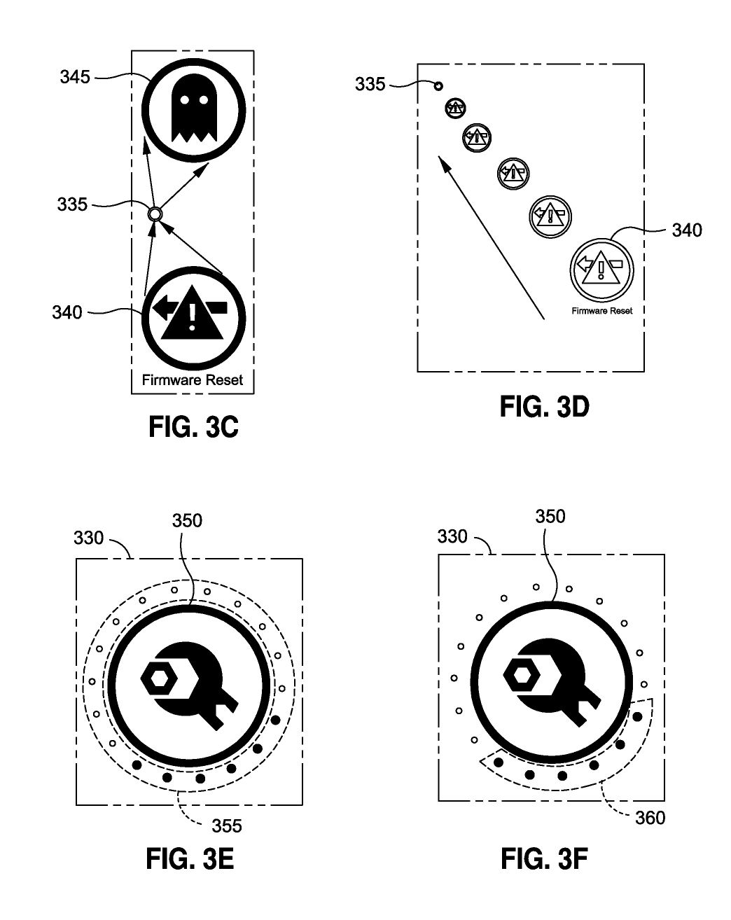

With reference now to FIGS. 3A-3F, depict various screenshots of the orbital menu system's interface, configured in accordance with the principles of the invention, being displayed by an electronic user device, such as electronic user device 100 of FIG. 1. Specifically, in FIG. 3A the graphical user interface 300 comprises a side menu 305, which includes various selectable icons, including orbit launcher icon 310, corresponding to menu levels of the orbital menu system. Upon selection of the orbit launcher icon 310, orbital menu system 315 may be displayed. As shown, orbital menu system 315 includes various selectable icons corresponding to lower menu levels, one of which is the settings menu icon 320.

FIG. 3B depicts the graphical user interface 300 after the settings menu icon 320 has been selected, and the settings menu is displayed on the orbital menu system 315. In this embodiment, the settings menu is comprised of 18 different icons, each of which corresponds to a function, additional submenu, option, or the like. As previously described, it would be difficult for a user to differentiate icons if all 18 available icons from the settings menu were displayed at the same time. Thus, FIG. 3B depicts one aspect of the invention of providing a graphical user interface 300 in which only a subset (i.e., 6 icons) of the total available icons (i.e., 18 icons) are displayed at any one time. Moreover, the user may quickly and conveniently access the other 12 un-displayed icons by touching and spinning the orbital menu system, depicted as spin effect 325 in FIG. 3B. Additionally, using the icon tracker 330, the user is able to always know exactly where the currently-displayed icons are in relation to the other, un-displayed available icons. Specifically, the icon tracker 330 shows how the currently-displayed icons are the lower 6 icons within the current submenu by virtue of the 6 filled dots shown at the bottom of the icon tracker.

As user applies spin effect 325, the displayed icons will similarly rotate clockwise towards the vanishing point 335 and graphically appear to vanish or sink into the lower side of the vanishing point 335. In this embodiment, the “Firmware” icon 340 would be the first icon to disappear since it is closest to the vanishing point 335. Also, as a result of the spin effect 325, the previously un-displayed icons would begin to graphically emerge from the opposite side of the vanishing point 335. For example, the “Stealth Mode” icon 345 may have been the first icon to “emerge” or be displayed as a result of the user's spin effect 325. This visual effect is shown in more detail with reference to FIGS. 3C and 3D, as described below. Finally, the current menu icon 350 may be used to indicate the current menu level of the orbital menu system 315. In this example, since the user previously selected the settings menu icon 320 of FIG. 3A, the current menu icon 350 corresponds to the settings menu.

Specifically, FIG. 3C shows how the most proximate icons 340 and 345 to the vanishing point 335 would graphically appear to “shrink” into the vanishing point 335, in the case of icon 340, or emerge and expand out of the vanishing point 335, in the case of icon 345. FIG. 3D more particularly shows the graphical “shrinking” effect on icon 340 as it moves (due to a user's spinning of the orbital menu system) in the direction towards the vanishing point 335.

FIGS. 3E and 3F depict more detailed versions of the icon tracker 330 of FIG. 3B. In particular, in FIG. 3E the icon tracker 330 more particularly illustrates the ring of visible icon indicators 355 arranged in an essentially circular pattern around the current menu icon 350, and along an inner ring of the selectable submenu icons (shown in FIG. 3B). As previously mentioned, the number of visible icon indicators (e.g., dots or symbols) which comprise the icon tracker 330 should preferably correspond to the total number of selectable icons on the current menu level. Additionally, those visible icon indicators within the ring 355 should differentiate between currently displayed submenu icons (shown in FIG. 3B) and hidden submenu icons, such that the user can readily determine the relative location of the displayed submenu icons within the set of all otherwise available icons for the current submenu (i.e., settings menu). In the embodiment of FIGS. 3E and 3F, the 6 filled dots 360 indicate the position of the 6 currently-displayed submenu icons (shown in FIG. 3B) in relation to the otherwise available, but un-displayed icons on the current menu level, which are shown as unfilled dots.

As such, the orbital menu system as disclosed herein enables larger, easier to read icons to be displayed on a graphical user interface, while at the same time allowing a larger number of icons to be available and easily selectable, without the user having to even change menu levels.

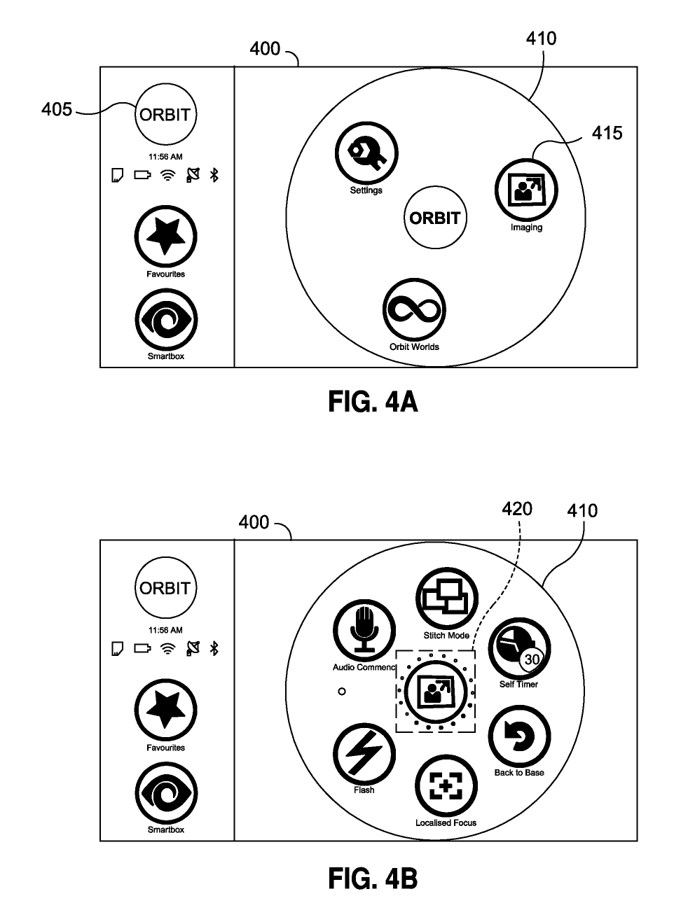

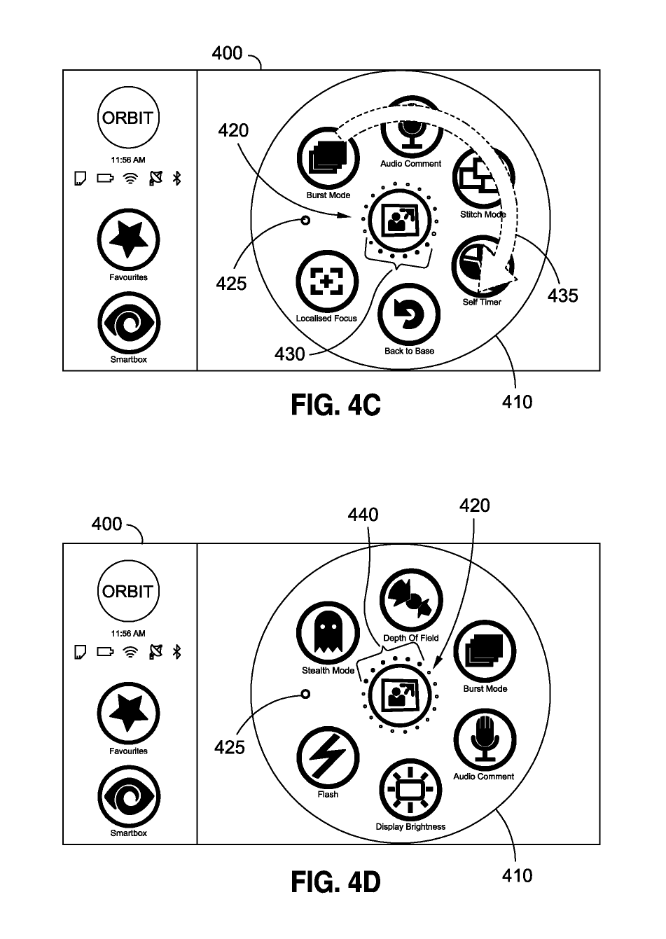

FIGS. 4A-4D are screenshots taken from an electronic user device, such as the electronic user device of FIG. 1, depicting additional functionalities and features of an orbital menu system configured in accordance with the principles of the invention. In particular, FIG. 4A depicts a graphical user interface 400 comprising a side menu that includes a number of selectable icons, including orbit launcher icon 405. In the example of FIG. 4A, the orbit launcher icon 405 has been selected so as to cause the orbital menu system 410 to be displayed. As shown, orbital menu system 410 includes various selectable icons corresponding to lower menu levels, one of which is the imaging menu icon 415, which may correspond to variously available imaging functions, options, etc.

Referring now to FIG. 4B, depicted is the graphical user interface 400 after the imaging menu icon 415 has been selected, and the imaging menu is displayed on the orbital menu system 410. Just as was the case with the settings submenu, in this example the imaging menu is also comprised of 18 different icons, each of which corresponds to different function, additional submenu, option, etc. Similarly, the icon tracker 420 shows exactly where the currently-displayed icons are in relation to the other, un-displayed available icons, i.e., the currently-displayed icons are the lower 6 icons within the settings submenu by virtue of the 6 filled dots shown at the bottom of the icon tracker 420.

Referring now to FIG. 4C, the graphical user interface 400 of FIG. 4B is shown after the user applies a spin effect 435 to the orbital menu system 410 by, for example, touching/contacting some portion of the graphical user interface within the orbital menu system 410 and making a swirling or circulating motion while still in contact with the screen. It should additionally be appreciated that the spin effect 435 may be initiated by the user using other forms of contact/motions.

Regardless of how the spin effect 435 is initiated, the submenu icons for the imaging submenu have begun to rotate from the orientation shown and described above in FIG. 4C. Specifically, in this example the submenu icons have advanced one spot with the “Burst Mode” having emerged from the vanishing point 425, and the previously-displayed “Flash” icon having disappeared into the vanishing point 435. Similarly, since the imaging submenu icons have all advanced one spot, the corresponding 6 highlighted/enlarged visible icon indicators 430 (i.e., filled dots) within the icon tracker 420 have similarly advanced by one spot.

FIG. 4D shows the graphical user interface 400 of FIG. 4B after the spin effect 435 of FIG. 4C has caused the orbital menu system 410 to further rotate the orbital menu system such that the 6 highlighted/enlarged visible icon indicators 430 (i.e., filled dots) within the icon tracker 420 have now rotated up near the top of the icon tracker 420, as shown in FIG. 4D. In this fashion, these aspects of the invention enable a user to, not only quickly determine how many un-displayed icons are available on a current menu level, but also the orientation of the currently-displayed icons amongst those available icons.

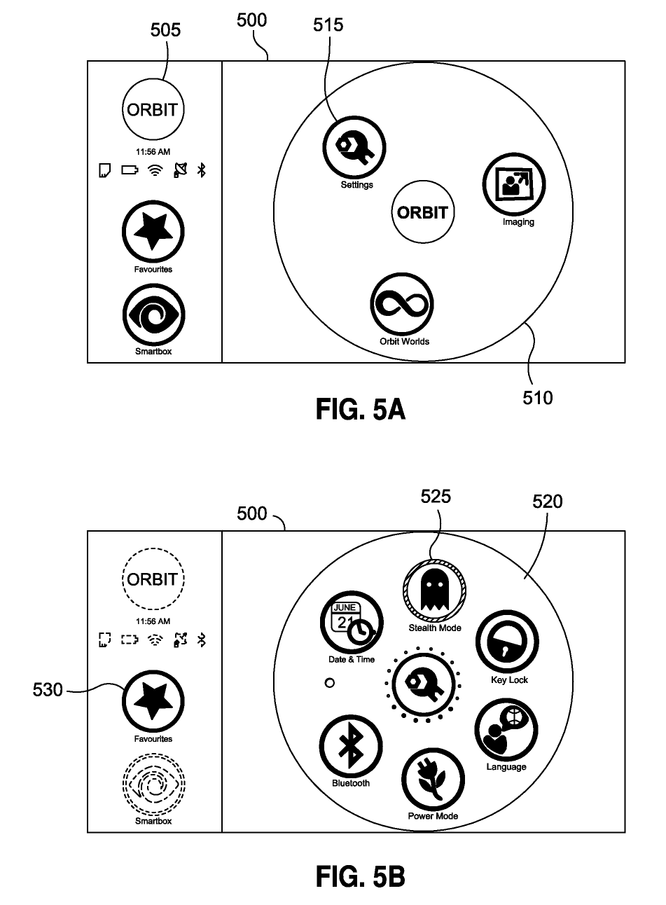

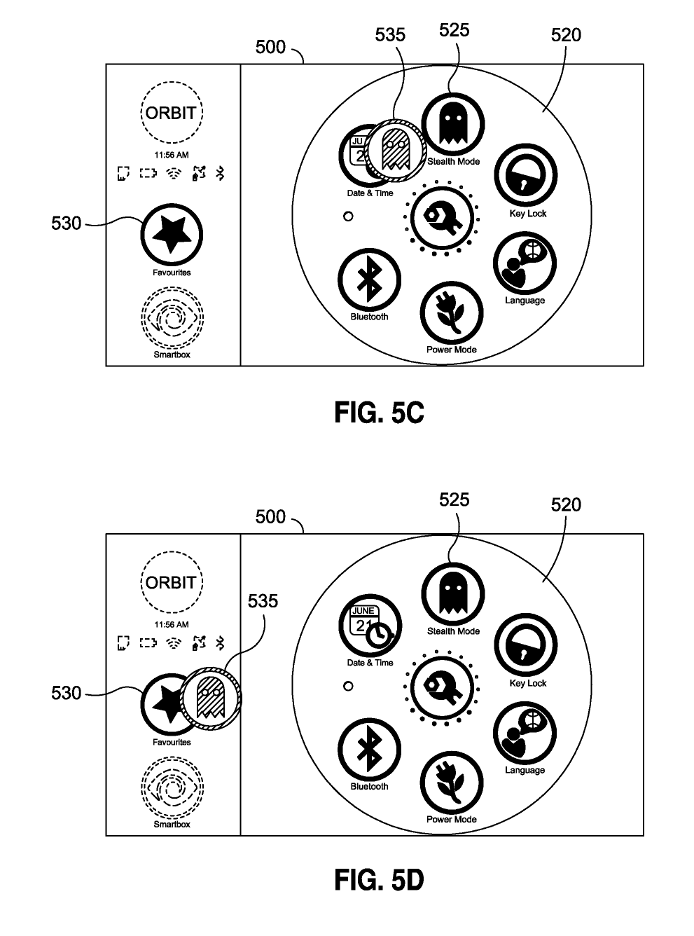

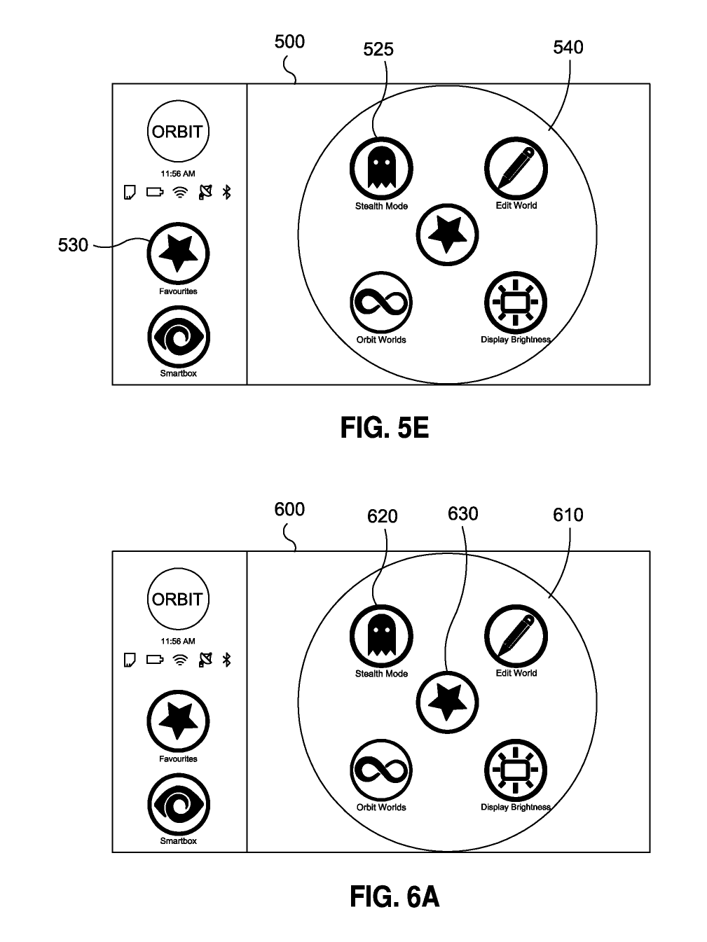

In addition to the various features and functionalities described above with respect to the spin effect, vanishing point and icon tracker, FIGS. 5A-5E illustrate additional aspects of the novel disclosed orbital menu system relating more specifically to the orbital menu's customization features. In particular, FIG. 5A depicts a graphical user interface 500 comprising a side menu that includes a number of selectable icons, including orbit launcher icon 505. In the example of FIG. 5A, the orbit launcher icon 505 has been selected so as to cause the orbital menu system 510 to be displayed. As shown, orbital menu system 510 includes various selectable icons corresponding to lower menu levels, one of which is the setting menu icon 515.

Referring now to FIG. 5B, depicted is the graphical user interface 500 after the settings menu icon 515 has been selected and the settings menu 520 displayed on the orbital menu system 510.

Additionally, one aspect of the novel orbital menu system is to enable users to customize the various orbital menus by, for example, selecting one or more icons to add or include in the favorites submenu. To that end, the side menu includes a ‘Favorites’ icon 530, which may be selected by a user in order to access the ‘Favorites’ submenu. Additionally, various icons may be added to the ‘Favorites’ submenu using a drag-and-drop operation. For example, the ‘Stealth Mode’ icon 525, which is highlighted in FIG. 5B to show that it has been selected (touched/contacted) by the user, may be added to the favorites submenu by performing a drag-and-drop operation.

FIG. 5C depicts moving icon 535 to graphically represent the beginning of such a drag-and-drop operation. While a quick tapping or touching of icon 525 by the user may result in selecting the corresponding function, a drag-and-drop operation may be performed by first contacting icon 525, and then maintaining contact with the moving icon 535 as the user drags it to a desired location, i.e., user's finger slides across the graphical user interface 500 until it reaches a desired location.

Continuing now to FIG. 5D, which shows a more advanced state of such a drag-and-drop operation as the moving icon 535 approaches the ‘Favorites’ icon 530. The user may end the drag-and-drop operation by, for example, dragging the moving icon 535 to a desired destination point, and then ending contact with graphical user interface 500 (e.g., lifting the user's finger off the display) once the moving icon 535 reaches the desired destination point, i.e., the ‘Favorites’ icon 530. The dragged icon, in this case the Stealth Mode icon 525, would be added to the user's favorites submenu, hence providing a quick and convenient means for customizing the orbital menu system. The result of the above drag-and-drop operation is shown in FIG. 5E, which shows the graphical user interface 500 after the favorites submenu has been accessed (e.g., icon 530 selected) and the favorites orbital submenu 540 displayed. As shown, the ‘Stealth Mode’ icon 525 is now part of the user's customized favorites submenu 540.

It should further be appreciated that icons may be moved/copied between any number or level of menu within the orbital menu system, in accordance with the principles of the invention as described above.

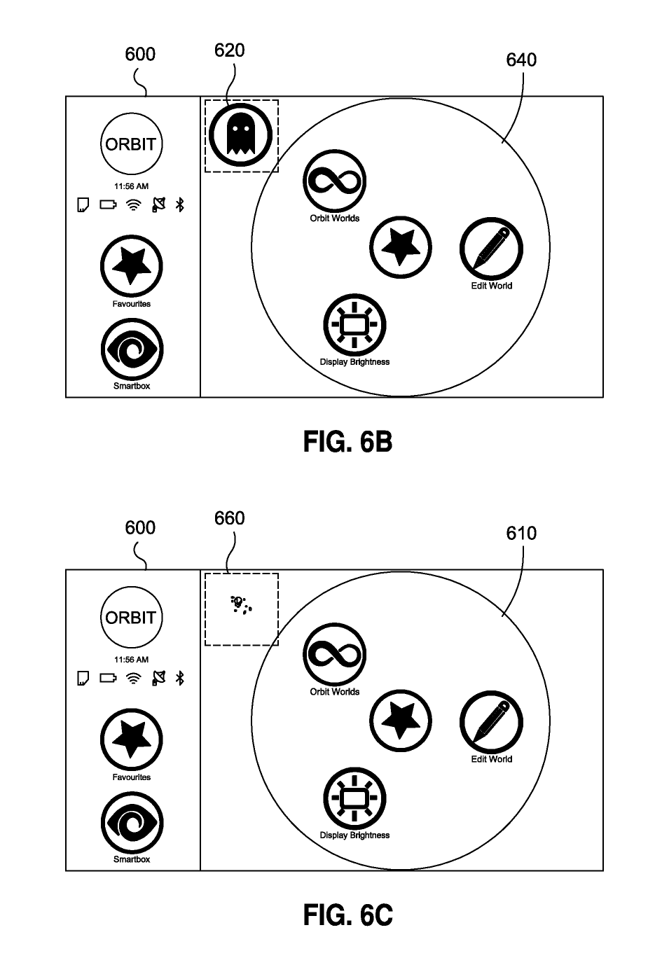

FIGS. 6A-6C depict various additional screenshots taken from an electronic user device, such as the electronic user device of FIG. 1, depicting additional functionalities and features of an orbital menu system configured in accordance with the principles of the invention. Specifically, FIGS. 6A-6C illustrate how the disclosed orbital menu system may be further customized by quickly and conveniently removing icons from specific menu levels. For example, in FIG. 6A, the favorites submenu 610 is being displayed on the graphical user interface 600, and includes a ‘Stealth Mode’ icon 620. The fact that the favorites submenu 610 is the current menu level may be represented by a menu level icon 630.

In one or more embodiments, the user may remove the ‘Stealth Mode’ icon 620 from the favorites submenu 610 by dragging the icon off of the orbital menu system. While tapping or touching the icon 620 may result in selecting the corresponding function, the icon may be removed from the current menu level by first contacting/touching the icon 620, and then maintaining contact with the icon until it reaches an open or designated area. To that end, FIG. 6B depicts how icon 620 has been dragged off of the favorites submenu 610 to an open area. Alternatively, the icon could have similarly been dragged to a designated area.

Continuing now to FIG. 6C, the operation of removing icon 620 from the favorites submenu 610 may be completed by ending contact with the graphical user interface 600 (e.g., lifting the user's finger off the display) once icon 620 reaches an open area or designated spot. The removal or deletion of the icon may then be graphically represented in any number of ways, including having the icon 620 evaporate or disintegrate, as shown in FIG. 6C, so as to signal to the user that the icon 620 has been removed from the favorites menu 610.

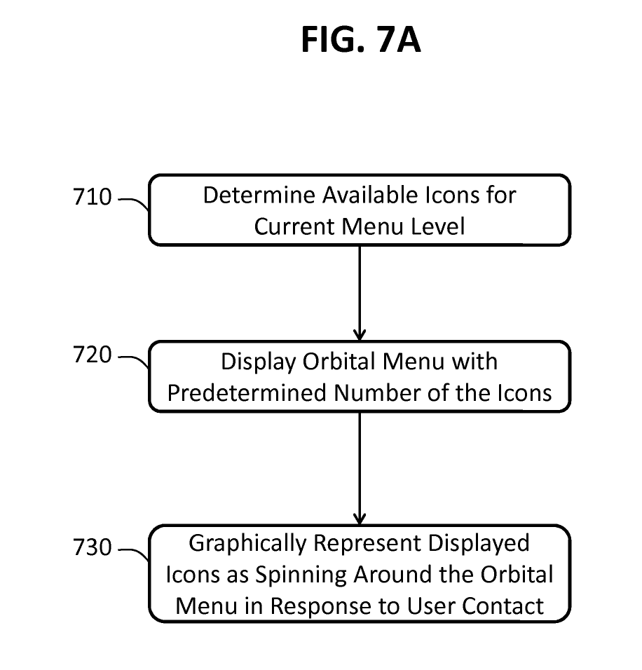

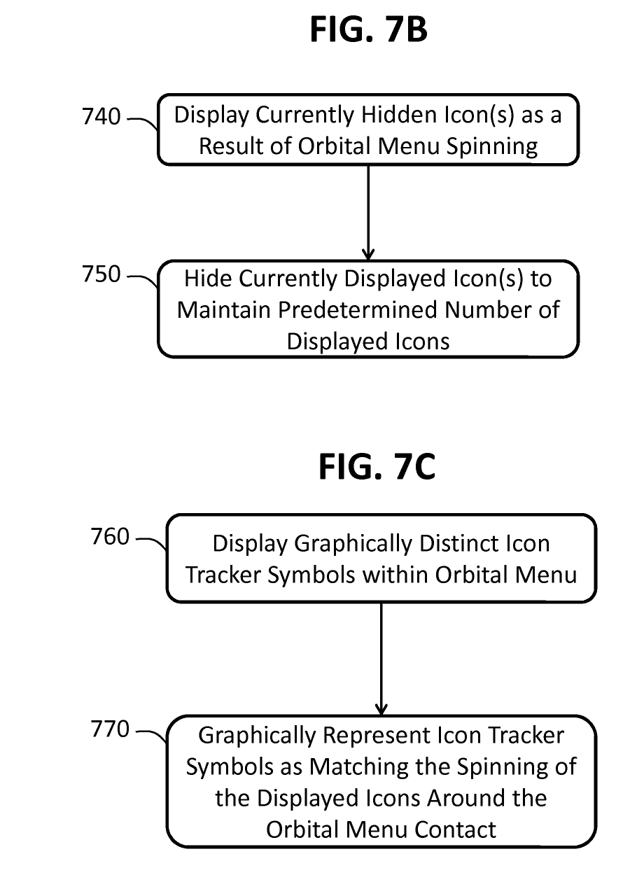

With reference now to FIGS. 7A-7C, depicted is a process for implementing a menu system for a graphical user interface (e.g., graphical user interface 300, 400, 500 or 600) interface displayed by an electronic user device (e.g., electronic user device 100 or 200), in accordance with the principles of the invention. The process begins at block 710 where a plurality of available icons for a current menu level of the orbital menu system are determined. The plurality of available icons may individually correspond to accessing device functions, menu levels and various device options, as described in detail above. The process may then continue to block 720 where an orbital menu may be displayed on a touchscreen display of the electronic user device. It should be appreciated that the orbital menu may be any of the exemplary orbital menus described herein with reference to FIG. 2B-2F, 3A-3B, 4A-4D, 5A-5E or 6A-6C. As also described above, this orbital menu includes only a predetermined number of the plurality of available icons. These predetermined number of icons are displayed as a plurality of selectable icons in a first essentially circular pattern. The remaining plurality of available icons for the current menu level may then be hidden from user view, such as by use of the above-described vanishing point.

The process of FIGS. 7A-7C may then continue to block 730 where the plurality of selectable icons may be graphically represented as spinning along the first essentially circular pattern in response to a user contact of the orbital menu. The user contact may comprise touching/contact of the touchscreen display at a location corresponding to the displayed orbital menu, followed by a predetermined user motion, such as a clockwise or counterclockwise swirling motion that occurs while the user remains in contact with the touchscreen display.

The process continues to block 740 of FIG. 7B where one or more currently hidden icons may be displayed in the orbital menu as a result of the above-referenced spinning effect of the plurality of selectable icons. The currently hidden icons are preferably one of the plurality of available icons for the current menu level.

At block 750, the process may then include hiding one or more of the currently displayed plurality of selectable icons such that a total number of icons displayed around the first essentially circular pattern of the orbit menu does not exceed the predetermined number as a result of the fact that one or more currently hidden icons will be displayed in accordance with the operation of block 740 above.

The operations of block 740 and 750 may be carried out by a vanishing point that is oriented along the first essentially circular pattern and within the path of the graphically spinning plurality of selectable icons. As described above with reference to FIGS. 2C, 2E, 3B-3D, 4C and 4D, displaying currently hidden icons (block 740) may comprise graphically representing the hidden icon as emerging from the vanishing point so as to join the already displayed selectable icons spinning along the first essentially circular pattern of the orbital menu. Similarly, hiding the currently displayed plurality of selectable icons (block 750) may comprise graphically representing such currently displayed plurality of selectable icons as vanishing into the vanishing point so as to no longer be included in the graphical representation of icons spinning along the first essentially circular pattern of the orbital menu.

The process continues to block 760 of FIG. 7C where a plurality of symbols may be displayed within the graphical user interface along a second essentially circular pattern that is radially displaced from the first essentially circular pattern (e.g., icon tracker 250, 330, 355 or 420). In certain embodiments, it may be preferable for each of such symbols to correspond to one of the plurality of available icons for the current menu level. At block 770, the process further comprises graphically distinguishing those symbols corresponding to the displayed plurality of selectable icons (e.g., filled dots) from those plurality of symbols corresponding to the remaining plurality of available icons that are hidden from user view (e.g., unfilled dots).

It should further be appreciated that, consistent with the icon trackers described above, the symbols may be graphically represented as spinning along the second essentially circular pattern in response to the user contact of the orbital menu, and in a manner consistent with said graphical representation of the plurality of selectable icons spinning along the first essentially circular pattern. This operation may preferably be done so as to maintain a graphical orientation of the graphically distinguished symbols to the plurality of available icons during said spinning.

Still another aspect of the invention is to provide a menu system for a graphical user interface of an electronic user device that allows for menu customization, including graphically representing the plurality of selectable icons as moving from the current menu level to an identified location, such as another submenu or a deletion area, as described above with reference to FIGS. 5A-5E and 6A-6C.

While various examples have been described herein with respect to specific submenus and icons, it should be appreciated that such examples are provided by way of illustration only and are not intended to limit the scope of the invention. This application is intended to cover any variations, uses or adaptation of the invention following, in general, the principles of the invention, and including such departures from the present disclosure as come within the known and customary practice within the art to which the invention pertains.

What is claimed is:

1. A method for providing an orbital menu system for a graphical user interface displayed on a touchscreen display of an electronic user device, the method comprising the acts of:
determining a plurality of available icons for a current menu level of the orbital menu system, wherein the plurality of available icons correspond to at least one of accessing device functions, menu levels and device options;
displaying, on the touchscreen display of the electronic user device, an orbital menu in which only a predetermined number of the plurality of available icons are displayed as a plurality of selectable icons in a first essentially circular pattern, and wherein the remaining plurality of available icons for the current menu level are hidden from user view; and
graphically representing, on the touchscreen display, the plurality of selectable icons as spinning along the first essentially circular pattern in response to a user contact of the orbital menu provided using the touchscreen display.

2. The method of claim 1, wherein the user contact comprises user contact of the touchscreen display at a location corresponding to the displayed orbital menu, followed by a predetermined user motion.

3. The method of claim 2, wherein the predetermined user motion comprises a clockwise or counterclockwise swirling motion that occurs while the user remains in contact with the touchscreen display.

4. The method of claim 1, further comprising:
receiving a user selection of one of the plurality of selectable icons corresponding to a submenu of the orbital menu system; and
displaying, in response to said user selection, the predetermined number of additional selectable icons within the orbital menu from a plurality of additional available icons corresponding to the submenu level.

5. The method of claim 1, further comprising:
displaying at least one currently hidden icon as a result of said graphical spinning of the plurality of selectable icons, wherein the at least one currently hidden icon is one of the plurality of available icons for the current menu level; and
hiding at least one of the displayed plurality of selectable icons such that a total number of icons displayed around the first essentially circular pattern of the orbit menu does not exceed the predetermined number as a result of said displaying at least one currently hidden icon.

6. The method of claim 5, wherein the orbital menu further comprises a vanishing point oriented along the first essentially circular pattern and within the path of the graphically spinning plurality of selectable icons.

7. The method of claim 6, and wherein displaying the at least one currently hidden icon comprises displaying a graphical representation of the at least one currently hidden icon as emerging from the vanishing point so as to join the graphical representation of icons spinning along the first essentially circular pattern of the orbital menu.

8. The method of claim 7, wherein hiding the at least one of the displayed plurality of selectable icons comprises displaying a graphical representation of the at least one displayed plurality of selectable icons as vanishing into the vanishing point so as to no longer be included in the graphical representation of icons spinning along the first essentially circular pattern of the orbital menu.

9. The method of claim 1, further comprising:
displaying a plurality of symbols along a second essentially circular pattern that is radially displaced from the first essentially circular pattern, wherein each of the plurality of symbols corresponds to one of the plurality of available icons for the current menu level; and
graphically distinguishing those plurality of symbols corresponding to the displayed plurality of selectable icons from those plurality of symbols corresponding to the remaining plurality of available icons that are hidden from user view.

10. The method of claim 9, graphically representing the plurality of symbols as spinning along the second essentially circular pattern in response to the user contact of the orbital menu, and in a manner consistent with said graphical representation of the plurality of selectable icons spinning along the first essentially circular pattern.

11. The method of claim 10, wherein graphically representing the plurality of symbols as spinning in a manner consistent with said graphical representation of the plurality of selectable icons spinning comprises maintaining a graphical orientation of the graphically distinguishing plurality of symbols to the plurality of available icons during said graphical representation of said spinning.

12. The method of claim 1, the method further comprises:
receiving a user selection of one of the plurality of selectable icons; and
graphically representing the one of the plurality of selectable icons as moving from the current menu level to an identified location.

13. The method of claim 12, wherein the identified location is an identified submenu of the menu system, and the method further comprises adding the one of the plurality of selectable icons to the identified submenu in response to a drag-and-drop user input.

14. The method of claim 12, wherein the identified location is a deletion area of the menu system, and the method further comprises deleting the selected plurality of selectable icons from the current menu level in response to a drag-and-drop user input.

15. An electronic user device comprising:
a touchscreen display;
a memory containing processor-executable instructions for implementing an orbital menu system on a graphical user interface displayable on the touchscreen display; and
a processor electrically coupled to the memory and the touchscreen display, the processor configured to execute the processor-executable instructions to:
determine a plurality of available icons for a current menu level of the orbital menu system, wherein the plurality of available icons correspond to at least one of accessing device functions, menu levels and device options,
display, on the touchscreen display, an orbital menu in which only a predetermined number of the plurality of available icons are displayed as a plurality of selectable icons in a first essentially circular pattern, and wherein the remaining plurality of available icons for the current menu level are hidden from user view, and
graphically represent, on the touchscreen display, the plurality of selectable icons as spinning along the first essentially circular pattern in response to a user contact of the orbital menu provided using the touchscreen display.

16. The electronic user device of claim 15, wherein the user contact comprises user contact of the touchscreen display at a location corresponding to the displayed orbital menu, followed by a predetermined user motion.

17. The electronic user device of claim 16, wherein the predetermined user motion comprises a clockwise or counterclockwise swirling motion that occurs while the user remains in contact with the touchscreen display.

18. The electronic user device of claim 15, wherein the processor is further configured to execute the processor-executable instructions to:
receive a user selection, via the touchscreen display, of one of the plurality of selectable icons corresponding to a submenu of the orbital menu system, and
display on the touchscreen display, and in response to said user selection, the predetermined number of additional selectable icons within the orbital menu from a plurality of additional available icons corresponding to the submenu level.

19. The electronic user device of claim 15, wherein the processor is further configured to execute the processor-executable instructions to:
display, on the touchscreen display, at least one currently hidden icon as a result of said graphical spinning of the plurality of selectable icons, wherein the at least one currently hidden icon is one of the plurality of available icons for the current menu level, and
hide at least one of the displayed plurality of selectable icons such that a total number of icons displayed around the first essentially circular pattern of the orbital menu does not exceed the predetermined number as a result of said displaying at least one currently hidden icon.

20. The electronic user device of claim 19, wherein the orbital menu further comprises a vanishing point oriented along the first essentially circular pattern and within the path of the graphically spinning plurality of selectable icons.

21. The electronic user device of claim 20, wherein the processor is further configured to display the at least one currently hidden icon by displaying, on the touchscreen display, a graphical representation of the at least one currently hidden icon as emerging from the vanishing point so as to join the graphical representation of icons spinning along the first essentially circular pattern of the orbital menu.

22. The electronic user device of claim 21, wherein the processor is further configured to hide displayed plurality of selectable icons by displaying, on the touchscreen display, a graphical representation of the at least one displayed plurality of selectable icons as vanishing into the vanishing point so as to no longer be included in the graphical representation of icons spinning along the first essentially circular pattern of the orbital menu.

23. The electronic user device of claim 15, wherein the processor is further configured to execute the processor-executable instructions to:
display a plurality of symbols along a second essentially circular pattern that is radially displaced from the first essentially circular pattern, wherein each of the plurality of symbols corresponds to one of the plurality of available icons for the current menu level, and
graphically distinguish those plurality of symbols corresponding to the displayed plurality of selectable icons from those plurality of symbols corresponding to the remaining plurality of available icons that are hidden from user view.

24. The electronic user device of claim 23, wherein the processor is further configured to execute the processor-executable instructions to graphically represent the plurality of symbols as spinning along the second essentially circular pattern in response to the user contact of the orbital menu, and in a manner consistent with said graphical representation of the plurality of selectable icons spinning along the first essentially circular pattern.

25. The electronic user device of claim 24, wherein the processor is further configured to execute the processor-executable instructions to graphically represent the plurality of symbols as spinning in a manner consistent with said graphical representation of the plurality of selectable icons spinning by maintaining a graphical orientation of the graphically distinguishing plurality of symbols to the plurality of available icons during said graphical representation of said spinning.

26. The electronic user device of claim 15, wherein the processor is further configured to execute the processor-executable instructions to:
receive a user selection, via the touchscreen display, of one of the plurality of selectable icons, and
graphically represent the one of the plurality of selectable icons as moving from the current menu level to an identified location.

27. The electronic user device of claim 26, wherein the identified location is an identified submenu of the menu system, and the processor is further configured to add the one of the plurality of selectable icons to the identified submenu in response to a drag-and-drop user input.

28. The electronic user device of claim 26, wherein the identified location is a deletion area of the menu system, and the processor is further configured to delete the selected plurality of selectable icons from the current menu level in response to a drag-and-drop user input.

29. A graphical user interface of an electronic user device with a touchscreen display, wherein the graphical user interface includes an orbital menu comprising:
a plurality of displayed selectable icons arranged in a first essentially circular pattern, wherein the plurality of selectable icons are a predetermined number of a plurality of available icons for a current menu level of the orbital menu, wherein the plurality of available icons correspond to at least one of accessing device functions, menu levels and device options;
a plurality of hidden icons, wherein the plurality of hidden icons correspond to the remaining plurality of available icons that exceed the predetermined number; and
a graphical representation of the plurality of selectable icons spinning along the first essentially circular pattern in response to a user contact of the orbital menu provided using the touchscreen display.

30. The graphical user interface of claim 29, wherein the user contact comprises user contact of the touchscreen display at a location corresponding to the displayed orbital menu, followed by a predetermined user motion.

31. The graphical user interface of claim 30, wherein the predetermined user motion comprises a clockwise or counterclockwise swirling motion that occurs while the user remains in contact with the touchscreen display.

32. The graphical user interface of claim 29, wherein the orbital menu further comprising a predetermined number of additional selectable icons from a plurality of additional available icons corresponding to a submenu of the orbital menu, wherein the additional selectable icons are displayed in response to a user selection of one of the plurality of selectable icons corresponding to the submenu of the orbital menu.

33. The graphical user interface of claim 29, wherein the orbital menu further comprising a vanishing point oriented along the first essentially circular pattern and within the path of the graphically spinning plurality of selectable icons.

34. The graphical user interface of claim 33, wherein the vanishing point is configured to:
graphically represent, as a result of said graphical spinning of the plurality of selectable icons, at least one currently hidden icon as emerging from the vanishing point so as to join the graphical representation of icons spinning along the first essentially circular pattern of the orbital menu, wherein the at least one currently hidden icon is one of the plurality of available icons for the current menu level; and
graphically represent at least one displayed plurality of selectable icons as vanishing into the vanishing point so as to no longer be included in the graphical representation of icons spinning along the first essentially circular pattern of the orbital menu, and such that a total number of icons displayed around the first essentially circular pattern of the orbit menu does not exceed the predetermined number as a result of said displaying at least one currently hidden icon.

35. The graphical user interface of claim 33, further comprising:
a plurality of symbols arranged along a second essentially circular pattern that is radially displaced from the first essentially circular pattern, wherein each of the plurality of symbols corresponds to one of the plurality of available icons for the current menu level, and
wherein those plurality of symbols corresponding to the displayed plurality of selectable icons are graphically distinguished from those plurality of symbols corresponding to the remaining plurality of available icons that are hidden from user view.

36. The graphical user interface of claim 35, wherein the orbital menu is further configured to graphically represent the plurality of symbols as spinning along the second essentially circular pattern in response to the user contact of the orbital menu, and in a manner consistent with said graphical representation of the plurality of selectable icons spinning along the first essentially circular pattern.

37. The graphical user interface of claim 36, wherein the orbital menu is further configured to graphically represent the plurality of symbols as spinning in a manner consistent with said graphical representation of the spinning plurality of selectable icons by maintaining a graphical orientation of the graphically distinguishing plurality of symbols to the plurality of available icons during said graphical representation of said spinning.

38. The graphical user interface of claim 29, wherein the orbital menu is further configured to graphically represent one of the plurality of selectable icons as moving from the current menu level to an identified location in response to a user selection of the one of the plurality of selectable icons.

39. The graphical user interface of claim 38, wherein the identified location is an identified submenu of the menu system, and wherein the orbital menu is further configured to graphically represent the addition of the one of the plurality of selectable icons to the identified submenu in response to a drag-and-drop user input.

40. The graphical user interface of claim 38, wherein the identified location is a deletion area of the menu system, and the method further comprises deleting the selected plurality of selectable icons from the current menu level in response to a drag-and-drop user input.
